(19) United States
(12) Patent Application Publication
(10) Pub. No.: US 2012/0278210 A1
(43) Pub. Date: Nov. 1, 2012

(54) Automated Stock Donation System

(76) Inventor: Jonathan J. Delshad, Santa Monica, CA (US)

(21) Appl. No.: 13/459,000

(22) Filed: Apr. 27, 2012

Related U.S. Application Data
(60) Provisional application No. 61/480,709, filed on Apr. 29, 2011.

(51) Int. Cl. G06Q 40/00

(52) U.S. Cl. 705/30; 705/35

(57) ABSTRACT

A computer system is provided for donating securities to an organization. The method of carrying out the donation process comprises the steps of (a) receiving transaction authorization from a donor, (b) generating a securities management account for an organization, wherein said account comprises information for accessing the organization's financial institution, (c) receiving authorization from a donor to donate securities to said organization, wherein said authorization comprises quantity of a particular security and donor's financial institution information, (d) communicating with donor's financial institution, (e) receiving securities from donor's financial institution; and (f) liquidating said securities on a securities market. The system can comprise one or more processors arranged to carry out the steps. Also, the system can comprise one or more computer-readable mediums encoded with executable code for carrying out the steps.

### CROSS-REFERENCE TO RELATED APPLICATION

This application claims the benefit of priority under 35 USC §119(e) to US Provisional application “Automated Stock Donation System” filed Apr. 29, 2011 and assigned Ser. No. 61/480,709. The entire content of this provisional application is hereby incorporated by reference as if fully set forth.

### TECHNICAL FIELD

The present disclosure generally relates to methods and systems for facilitating securities donation, and more particularly to automated stock donation to non-profit organizations.

### DESCRIPTION

There is a need for facilitating the process of donating securities to a non-profit organization. In general, donating shares of appreciated securities such as corporate stock to a non-profit organization can be incredibly tax-efficient because one can eliminate paying taxes on the capital gain, but it is a big hassle. The non-profit must have a brokerage account and the donor needs to get his brokerage firm to transfer the shares to the non-profit or provide confidential brokerage information to the non-profit in order for them to process the order. It also takes extra effort to make sure the non-profit knows where the transfer came from, and since most non-profit organizations receive relatively few stock donations, obtaining a correct acknowledgment for tax purposes requires extra effort. Additionally, because the process can take weeks to complete and stock prices fluctuate daily, the value of the donation can fluctuate from the time when the donor makes his request to donate until the donation is made, causing uncertainty in the tax benefit to the donor. To date, this process has not yet been automated, usually requiring a substantial amount of time and paperwork to complete. As a result, many non-profits do not accept stock donations and many people do take the stock donation route for making charitable contributions.

### SUMMARY

In one embodiment, a computer system for donating securities to an organization comprises one or more processors arranged to (a) receive transaction authorization from a donor, (b) generate a securities management account for an organization, wherein said account comprises information for accessing the organization's financial institution, (c) receive authorization from a donor to donate securities to said organization, wherein said authorization comprises quantity of a particular security and donor's financial institution information, (d) communicate with donor's financial institution, (e) receive securities from donor's financial institution; and (f) liquidate said securities on a securities market.

In another embodiment, a method for donating securities to an organization comprises using one or more processors arranged to (a) receive transaction authorization from a donor, (b) generate a securities management account for an organization, wherein said account comprises information for accessing the organization's financial institution, (c) receive authorization from a donor to donate securities to said organization, wherein said authorization comprises quantity of a particular security and donor's financial institution information, (d) communicate with donor's financial institution, (e) receive securities from donor's financial institution; and (f) liquidate said securities on a securities market.

In a further embodiment, at least one processor is arranged to affect transfer of at least a portion of proceeds from liquidating the securities, to the organization's financial institution. Further, at least one processor is arranged to subtract a flat fee or percentage fee from the value of the liquidated securities prior to transferring the proceeds to the organization's financial institution. The processors may be arranged to generate and send an accounting statement to the organization, as well as generating a receipt and sending the same to the donor.

In yet another embodiment, a computer system for donating securities to an organization comprises more or more computer-readable mediums encoded with executable code for (a) receiving transaction authorization from a donor, (b) generating a securities management account for an organization, wherein said account comprises information for accessing the organization's financial institution, (c) receiving authorization from a donor to donate securities to said organization, wherein said authorization comprises quantity of a particular security and donor's financial institution information, (d) communicating with donor's financial institution, (e) receiving securities from donor's financial institution; and (f) liquidating said securities on a securities market.

In a further embodiment, at least one computer-readable medium is encoded with executable code for affecting transfer of at least a portion of proceeds from liquidating the securities, to the organization's financial institution. Further, the computer-readable medium may be encoded with executable code for subtracting a flat fee or percentage fee from the value of the liquidated securities prior to transferring the proceeds to the organization's financial institution. Finally, the computer-readable medium my be encoded with instructions for generating and sending an accounting statement to the organization, as well as generating a receipt and sending the same to the donor.

### BRIEF DESCRIPTION OF THE DRAWINGS

FIG. 1 is a diagram of a simplified embodiment.

FIG. 2 is a diagram illustrating the steps involved in one embodiment.

FIG. 3 is a diagram illustrating the steps involved in another embodiment.

FIG. 4 depicts an example of a securities donation application on a website of a non-profit organization.

### DETAILED DESCRIPTION

The present embodiments describe methods and systems for donating securities to an organization. A general embodiment involves a method of managing donations to an organization comprising the steps of: (a) providing a securities management system that allows a donor to donate securities through a website, (b) receiving authorization from the donor on said securities management system, (c) receiving securities from donor's financial institution onto said securities management system, and (d) liquidating the securities and transferring at least a portion of the proceeds to the organization's financial institution. The computer system may comprise one or more processors for carrying out the each step. Moreover, the computer system may comprise one or more computer-readable mediums encoded with executable code which correspond to each step of the methods involved.

The present embodiments provide methods and systems for a person or an entity to donate securities to an organization for potential tax benefits. A non-limiting example of tax benefits includes exemption from paying capital gains taxes on the sale or transfer of appreciated securities. Another non-liming example includes tax deduction as a charitable contribution. In the preferred embodiments the donor receives both capital gains tax exemption and a charitable contribution deduction.

Generally, tax benefits apply when the recipient organization is eligible for tax exemption. Thus, in one embodiment, the organization is an entity that is considered tax-exempt by the Internal Revenue Services (“IRS”). In another embodiment, the organization is a tax-exempt entity falling within section 501(c)(3) of the Internal Revenue Code (“IRC”). In a specific embodiment, the organization is a charitable organization. In yet another specific embodiment, the organization is a non-profit organization.

In the present embodiments, a donor can donate virtually any type of security such as debt, equity and hybrid securities. Non-limiting examples include stocks, bonds, mutual funds, exchange traded funds, options, futures and swaps. In some embodiments, the securities to be donated exclude physical stock certificates held by the owner of the stock (rather than a brokerage firm). The system of the present embodiments may be used to transfer securities residing on traditional, electronic, and alternative exchanges.

A donor may donate securities in a variety of ways. In a general embodiment, a donor electronically transfers title to a set quantity of securities. In a specific embodiment, the donor uses a securities management system, as described herein, to transfer title to a set quantity of securities to a non-profit organization.

In a general embodiment, the securities management system comprises hardware capable of carrying out instructions corresponding to the each step of the donation process. As such, in one embodiment, the system comprises at one or more processors arranged to carry out executable code corresponding to each step. The one or more processors may act collectively, to carry out the entire process. For instance, each processor may carry out a separate step. Alternatively, one processor can carry out most of the steps. In one embodiment, one processor executes all the instructions corresponding to donation steps.

The system hardware may comprise one or more computer-readable mediums which are encoded with executable code (e.g. algorithm) for carrying out each step of the donation process. In a specific embodiment, the securities management system comprises executable code installed on the hard drive of a server. In yet another embodiment, the system comprises executable code installed on a removable hard disk. In still another embodiment, the system comprises executable code installed on the memory of a plurality of computers in a network.

The executable code of some embodiments may be installed on computers, or a computer—readable medium, in the same network but located at different sites. For instance, the computers may be located at the donor's financial institution, the non-profit organization site, the site of the company offering the securities management system, or any combination thereof.

The securities management system interfaces with the donor to allow user to authorize transfer of title to his/her securities. In a preferred embodiment, the securities management system communicates with the donor's financial institution and the non-profit's financial institution to affect transfer of title. As such, the executable code of the securities management system may carry out various functions.

In one embodiment, the system comprises executable code for a website. The website could provide a user interface which allows the donor to initiate a transaction with the non-profit organization. The donor may be prompted to enter log-in information for his/her brokerage account and identify the name and quantity of a particular security to be donated. The information may be entered in a variety of methods including, but not limited to, via mobile and wireless devices. The web page may display what type of tax benefits (e.g. exemption, deduction, etc.) the transaction potentially qualifies for. The donor may, on the same page or a different page, confirm the transaction. The website may or may not be owned by the non-profit organization.

The donor may authorize securities transfer in a number of ways. In one embodiment, the donor fills in the appropriate fields on a website (that is part of the securities management system) which transmits the authorization to the donor's financial institution. In another embodiment, the donor downloads the authorization form from the securities management website, and the donor himself transmits the authorization to his financial institution. In a preferred embodiment, the donor virtually (electronically) signs the authorization on the website.

In one embodiment the system comprises executable code for interfacing the system with the donor's financial institution. That is, the executable code is compatible with that of the donor's financial institution such that it can submit a request for transfer of title as specified by the donor. Preferably, the donor's financial institution comprises a brokerage account. In a special embodiment, the executable code for securities donation, of the donor's financial institution is embedded within the securities management system website. In another special embodiment, the securities management website comprises a link to the donor's financial institution account management website.

In one embodiment, the system comprises executable code for interfacing the system with the non-profit's financial institution. In one embodiment, the non-profit has an account with a financial institution for receipt of securities, or proceeds from selling the same. More preferably, this account is a brokerage sub-account.

Once the donor authorizes the securities transfer, the securities management system awaits receipt of title to the specified securities. Since the system receives the donation on behalf of the non-profit, it is preferable that, in advance, the non-profit provide the securities management system administrators with legal authority (e.g. as an agent) to act on behalf of the non-profit, and provide the securities management system administrators with all other necessary information in order to act as an agent for the non-profit.

Preferably, the securities transfer is completed within the same business day. More preferably, the transfer is complete before the close of the appropriate market the same day. Most preferably the transfer is complete with sufficient time to liquidate securities the same day. Accordingly, the system website may place a cut-off time during each day for donating securities in order to ensure sufficient time to receive the securities and liquidate them in the relevant public exchange market. This better protects against selling the securities at a price below its basis value thereby losing the capital gains tax advantages.

Another tactic against losing the price basis would be for the donor to specify a price below which the securities are not to be transferred. For instance if the donor authorizes the transfer at the end of the day, the donor may instruct that the securities not be transferred if the price of the securities drops below a certain value when the stock market opens the next day. Moreover, the donor may specify a period of time (e.g. a month) in which the securities could be transferred if they rise above a certain value, and if not, no transaction would take place.

After receipt of title to the securities, the securities management system liquidates the securities and transfers at least a portion of the proceeds to the non-profit's financial institution of choice. Thus in one embodiment the system comprises executable code which causes the donor's securities to be sold in the relevant market. For example, such program may interface with, or reside on the hard drive of a brokerage firm, such that it can directly or indirectly conduct the sale by placing a market order with a broker. Electronic stock transferring is a known technique. US 2009/0018945 A1 teaches systems and methods for facilitating electronic securities transactions and is hereby incorporated by reference as if fully set forth.

The proceeds from liquidating the securities can be managed according to a prior agreement with the non-profit organization in which the non-profit can decide when and how to liquidate its stock or if it would prefer to have the stock transferred to a permanent brokerage account.

Thus, in one embodiment, the system includes executable code that apportions the proceeds (value of the liquidated securities). In a further embodiment the system comprises executable code for retaining portion of the securities transaction and transfers the rest to the non-profit. The portion retained by transferring to a separate financial institution (e.g. bank). The system may subtract a flat fee or a commission percentage from the proceeds. For example, the flat fee may be an annual subscription rate or on a per-use basis. The commission route can vary according to existing business practices. For example the system may subtract a fee of about 0.1 percent to about 20 percent from the proceeds and transfer the rest to the non-profit's financial institution. In another example, both a flat fee and percentage commission apply. For example, the donor-person or entity may purchase a license or subscription to the securities management for a certain flat fee (e.g. annual fee) and also pay a commission (e.g. 0.1-20%) on each completed transaction.

Following division of the proceeds, the securities management system can provide the non-profit organization with a receipt of the transaction. In one such embodiment, the securities management system comprises executable code for generating an accounting statement of one or more securities donations. In a further embodiment, the system comprises executable code for providing the non-profit organization an accounting statement after each transaction. In another embodiment, the system provides an accounting statement on a periodic basis, such as monthly, quarterly, annually, or a combination thereof. The accounting statement can provide information such as name of donor, time of donation, liquidation value, tax value to donor, total proceeds to organization, and any other information necessary to the organization for accounting purposes.

The securities management can also provide the donor with a receipt of the transaction. In one such embodiment, the system comprises executable code for generating a receipt acknowledging the securities donation transaction. In a further embodiment, the system comprises executable code for providing the donor with the acknowledgment receipt, on behalf of the non-profit organization. Preferably, the receipt provides all the data necessary to evidence a charitable donation for tax purposes. More preferably the receipt provides all information necessary to evidence a donation that qualifies for a capital gains tax exemption.

One particular aspect of the present embodiments is that the entire process, after the donor authorizes the transaction, can be fully automated. Therefore, once the donor authorizes the transaction, the system can automatically 1) communicate with the donor's financial institution, 2) receive title to the donated securities, 3) liquidate the securities, 4) retain a portion of the proceeds, 5) transfer a portion of the proceeds to non-profit organization, 6) provide an accounting statement to the non-profit, and 7) provide a donation receipt to the donor.

Preferably, each communication between the securities management system, donor's financial institution and non-profit's financial institution is encrypted and electronically signed. Encryption is a known technique. U.S. Pat. No. 4,405,829 teaches R.S.A. data encryption and digital signing and is hereby incorporated by reference with respect to such teachings.

Based on the foregoing description, a person skilled in the art of computer science can engineer a vast array of different securities management systems that reflect one more of the above embodiments. A few examples of such systems are described below without any intent to limit the scope of the present embodiments.

In a non-limiting embodiment, the securities management system comprises:

at least one computer-readable medium encoded with:

(a) executable code for receiving securities transaction authorization from a donor;

(b) executable code for communicating with the donor's financial institution

(c) executable code for communicating with the non-profit's financial institution;

(d) executable code for receiving title to securities from the donor's financial institution; and

(e) executable code for affecting sale of donor's securities on a public exchange.

In another embodiment, the securities management system further comprises at least one computer-readable medium encoded with:

(f) executable code for apportioning proceeds from sale of donor's securities.

In yet another embodiment the system comprises at least one computer-readable medium encoded with:

(g) executable code for generating an accounting statement for the non-profit organization.

In still another embodiment, the securities management system comprises at least one computer-readable medium encoded with:

(h) executable code for generating an acknowledgement receipt of the transaction to the donor.

In one embodiment, one or more of executable codes (a)-(h) reside on one or more computers, servers, removable drives or a combination thereof.

In one embodiment, one or more of executable codes (a)-(h) reside on a computer maintained by the non-profit organization's financial institution.

In one embodiment, one or more of executable codes (a)-(h) reside on a computer maintained by donor's financial institution.

In one embodiment, one or more processors are arranged to carry out instructions of codes (a)-(h).

### DETAILED DESCRIPTION OF THE FIGURES

The following description of the figures below is intended to supplement the description above and is not intended to limit the present embodiments in any way.

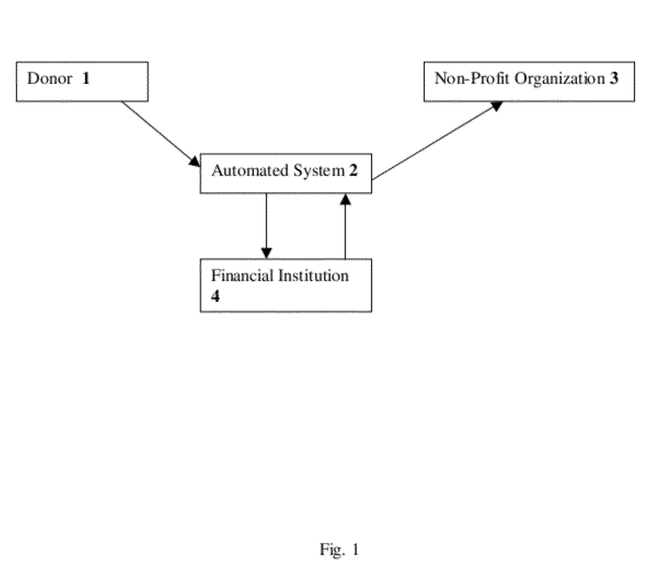

FIG. 1 is a highly generalized version of an embodiment. Here, the Automated System 2, receives authorization from a Donor 1, for a donation. The Automated System also communicates with a Financial institution 4. Finally, the Automated System 2, communicates with the Non-profit Organization 3.

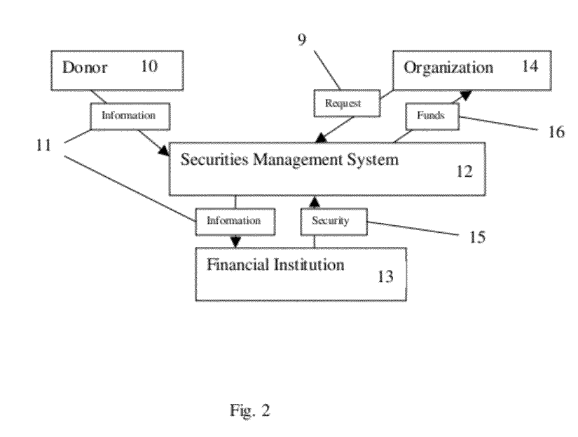

FIG. 2, depicts an example where an Organization, 14, wishes to be able to allow Donor, 10, to donate the Donor's securities to the Organization 14. First, the Organization 14 will provide a Request, 9, to the Securities management system 12, providing the Securities management system 12 with contact information of the Organization 14 and sufficient information including tax ID number, address, charter documents, and resolutions in order to set up an account with the Security Management System 12. A Donor 10, will provide the Securities Management System with relevant Information 11, which includes the security to be transferred, the name of the brokerage where such securities are held, the name of the donor, and any information necessary to authorize a transfer of such Security (or Securities) 15 to the Organization 14. The Securities Management System 12 will then communicate the Information 11, to the Financial Institution 13, and receive title to Securities 15. Upon liquidating the Securities 15, the Securities Management System 12 transfers Funds 16 from the proceeds of the sale of the Securities, 15 to the Organization.

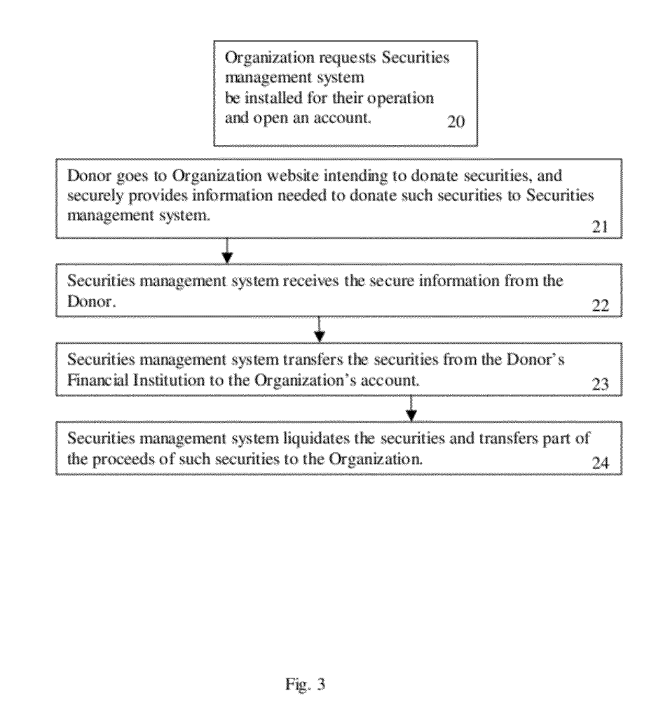

In FIG. 3, the flow diagram depicts the sequential steps in one example of setting up a securities management system and processing a donation. Accordingly, in step 20, the Organization first requests a donation account to be set up which in one embodiment comprises the securities management system receiving necessary information to set up a sub-brokerage account in the Organization's name, standing orders for liquidation of donated stock, and a webpage for the Organization for receiving stock donations. Next, in 21, the Donor inputs information regarding itself, the stocks it wishes to transfer and its brokerage account on the Organization's webpage that was previously created after the request in Step 20. The securities management system, in 22, receives the input from the donor and recognizes the source of the request from the Organization that registered with it in Step 20. In the next step 23, the securities management system transfers title to the securities from the donor's account to the Organization's sub account with the securities management system. In the final step 24, the securities management system liquidates the securities in accordance with standing orders provided to the securities management system by the Organization in Step 20, and donates part of the proceeds to the Organization. 24.

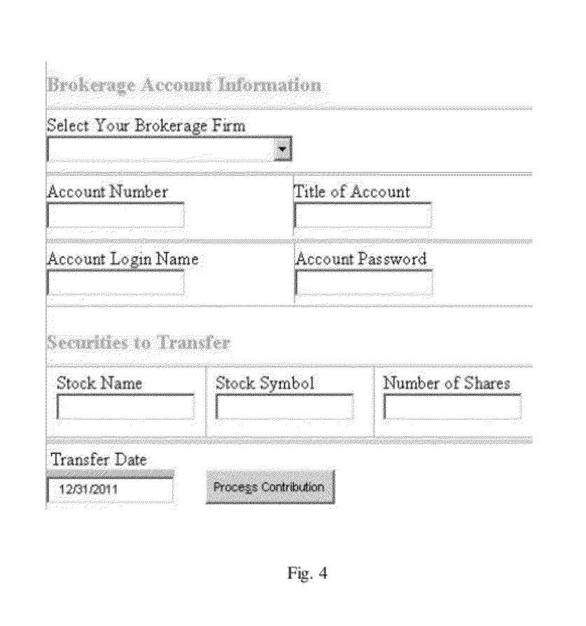

The illustration in FIG. 4, represents one of numerous ways a donor may be prompted to enter data necessary to affect transfer of securities. In this particular example, the user provides log-in information to his brokerage firm, identifies the stock and the quantity to be transferred. This application may be on the non-profit's own website, maybe on the donor's financial institution's website, or on a third party server. Although not depicted, the website can also provide the user with the option to electronically sign and confirm the transaction.

### Working Examples

In a non-limiting example, a non-profit organization provides the necessary information and subsequently, (1) a brokerage sub account is created for the organization, (2) a new webpage is integrated into their website which allows them to accept donations directly from their own website, (3) donated stock is instantly transferred out of the donor's account into the organizations brokerage account, (4) the stock is liquidated in accordance with the organization's standing instructions and the resulting cash is transferred to the organization, (5) simple accounting statements are provided to the organizations, and (6) receipts are provided on behalf of the organizations to the donors.

While the foregoing written description of the embodiments enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A computer system for donating securities to an organization comprising one or more processors arranged to:
receive transaction authorization from a donor;
generate a securities management account for an organization,
wherein said account comprises information for accessing the organization's financial institution;
receive authorization from a donor to donate securities to said organization,
wherein said authorization comprises quantity of a particular security and donor's financial institution information;
communicate with donor's financial institution;
receive securities from donor's financial institution; and
liquidate said securities on a securities market.

2. The system of claim 1, wherein at least one processor is further arranged to affect transfer of at least a portion of proceeds from liquidating the securities, to the organization's financial institution.

3. The system of claim 2, wherein at least one processor is further arranged to subtract a flat fee or a percentage fee from the value of the liquidated securities prior to transferring the proceeds to the organization's financial institution.

4. The system of claim 3, wherein at least one processor is arranged to generate an accounting statement reflecting transfer of proceeds.

5. The system of claim 4, wherein at least one processor is arranged to send the accounting statement to the organization.

6. The system of claim 3, wherein at least one processor is arranged to generate a receipt reflecting said transfer.

7. The system of claim 6, wherein at least one processor is arranged to send the receipt to the donor.

8. The system of claim 1, wherein the donor's authorization further comprises a virtual signature.

9. The system of claim 1, wherein the donor's authorization is received through a website.

10. The system of claim 1, wherein said system comprises only one processor.

11. A method for donating securities to an organization comprising using one or more processors arranged to:
receive transaction authorization from a donor;
generate a securities management account for an organization,
wherein said account comprises information for accessing the organization's financial institution;
receive authorization from a donor to donate securities to said organization,
wherein said authorization comprises quantity of a particular security and donor's financial institution information;
communicate with donor's financial institution;
receive securities from donor's financial institution; and
liquidate said securities on a securities market.

12. The method of claim 11, wherein at least one processor is further arranged to affect transfer of at least a portion of proceeds from liquidating the securities, to the organization's financial institution.

13. The system of claim 12, wherein at least one processor is further arranged to subtract a flat fee or a percentage fee from the value of the liquidated securities prior to transferring the proceeds to the organization's financial institution.

14. The system of claim 13, wherein at least one processor is arranged to generate an accounting statement reflecting transfer of proceeds and send said statement to the organization.

15. The system of claim 14, wherein at least one processor is arranged to generate a receipt reflecting said transfer and send said receipt to the organization.

16. A system for donating securities to an organization comprising more or more computer-readable mediums encoded with executable code for:
receiving receive transaction authorization from a donor;
generating a securities management account for an organization,
wherein said account comprises information for accessing the organization's financial institution;
receiving authorization from a donor to donate securities to said organization,
wherein said authorization comprises quantity of a particular security and donor's financial institution information;
communicating with donor's financial institution;
receiving securities from donor's financial institution; and
liquidating said securities on a securities market.

17. The method of claim 16, wherein at least one computer-readable medium is further encoded with executable code for transferring of at least a portion of proceeds from liquidating the securities, to the organization's financial institution.

18. The system of claim 17, wherein at least one computer-readable medium is encoded with executable code for subtracting a flat fee or a percentage fee from the value of the liquidated securities prior to transferring the proceeds to the organization's financial institution.

19. The system of claim 18, wherein at least one computer-readable medium is encoded with executable code for generating an accounting statement reflecting transfer of proceeds and sending said statement to the organization.

20. The system of claim 19, wherein at least one computer-readable medium is encoded with executable code for generating a receipt reflecting said transfer and sending said receipt to the organization.
